(19) United States
(12) Patent Application Publication
(10) Pub. No.: US 2002/0123902 A1
(43) Pub. Date: Sep. 5, 2002

(54) Method, system and storage medium for managing and providing access to legal information

(76) Inventors: Charles H. Lenore, West Hartford, CT (US); Robert A. Brooks, Eastford, CT (US)

Correspondence Address: CANTOR COLBURN, LLP, 55 GRIFFIN ROAD SOUTH, BLOOMFIELD, CT, 06002

(21) Appl. No.: 10/020,616

(22) Filed: Dec. 13, 2001

Related U.S. Application Data
(60) Provisional application No. 60/256,020, filed on Dec. 15, 2000.

(51) Int. Cl. G06F 17/60

(52) U.S. Cl. 705/1

(57) ABSTRACT

An exemplary embodiment is a method for managing legal information related to at least one legal matter in a system including a legal enterprise and a storage system coupled via a network. The method includes storing legal information in a database associated with the storage system. The legal information includes an evidentiary outline corresponding to the legal matter. The evidentiary outline includes a party's position and a link to evidence stored in the database supporting the party's position. Access to the legal information is provided to a client via the network.

### CROSS-REFERENCE TO RELATED APPLICATIONS

This application claims the benefit of U.S. provisional patent application serial No. 60/256,020 filed Dec. 15, 2000, the entire contents of which are incorporated herein by reference.

### BACKGROUND OF THE INVENTION

The invention relates generally to a method and system for managing and providing access to legal information and in particular to a method and system for creating, editing and accessing an evidentiary outline. In the legal profession, clients often desire access to legal information pertaining to a client matter. For example, in the context of a litigation, a client involved in the litigation may request access to status information, legal documents, court dockets, scheduled activities, billing information, etc. Existing systems allow authorized individuals to access such legal information. Authorized individuals include attorneys handling the client matter and client personnel having authority to access such legal information. Such access may be provided remotely through a computer network such as the Internet.

Although existing systems allow access to legal information from remote locations via a computer network, such systems require knowledge of the underlying litigation for efficient usage. For example, to access a document containing evidence supporting a factual finding, the user must know which documents (e.g., deposition transcript of John Smith) support the factual finding. Thus, it may be difficult for the user to access relevant documents.

### SUMMARY OF THE INVENTION

An exemplary embodiment is a method for managing legal information related to at least one legal matter in a system including a legal enterprise and a storage system coupled via a network. The method includes storing legal information in a database associated with the storage system. The legal information includes an evidentiary outline corresponding to the legal matter. The evidentiary outline includes a party's position and a link to evidence stored in the database supporting the party's position. Access to the legal information is provided to a client via the network.

### BRIEF DESCRIPTION OF THE DRAWINGS

FIG. 1 is a block diagram of an exemplary system for managing legal information.

FIG. 2 depicts an exemplary matter selection user interface.

FIG. 3 depicts an exemplary main user interface.

FIG. 4 depicts an exemplary main evidentiary outline user interface.

FIG. 5 depicts an exemplary evidentiary outline.

### DETAILED DESCRIPTION OF THE PREFERRED EMBODIMENT

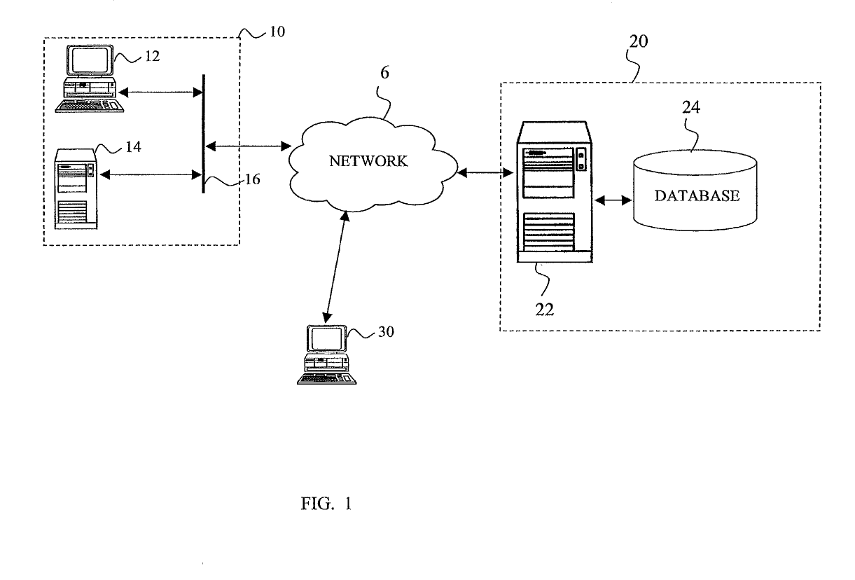

FIG. 1 is a block diagram of an exemplary system for managing legal information. The system of FIG. 1 includes a legal enterprise 10 that is the primary source of legal information. Legal information is intended to have a broad meaning and includes case plans, status information, legal documents, court dockets, scheduled activities, billing information, evidentiary outlines, etc. The legal enterprise 10 may be a law firm, corporate law department, government law department, etc. Typically, the legal enterprise 10 includes a number of legal enterprise systems 12 coupled to a legal enterprise server 14 via a network 16, such as a local area network (LAN). The legal enterprise system 12 may be the personal computer of an attorney or paralegal. The legal enterprise system 12 may be implemented using a general-purpose computer executing a computer program for carrying out the processes described herein. Alternatively, legal enterprise system 12 may be implemented using a device programmed primarily for accessing network 16 such as a network computer. The legal enterprise server 14 may be implemented using existing servers executing a computer program for carrying out the processes described herein. A firewall (not shown) may be included to prevent access to legal enterprise server 14 and/or network 16. The legal enterprise systems 12 and legal enterprise server 14 execute software applications to generate or digitize the legal information. Such applications may include word processing, spreadsheet, billing, scheduling and scanning applications.

As legal information is generated it may be stored on legal enterprise server 14. The legal information is also transferred to storage system 20 over network 6. The network 6 may be any type of known network including a wide area network (WAN), secure network (e.g., extranet, virtual private network), global network (e.g., Internet), etc. One or both of the legal enterprise 10 and the storage system 20 may be connected to the network 6 in a wireless fashion. In a preferred embodiment, the network 6 is the Internet and each legal enterprise system 12 executes a user interface application (e.g., web browser) to contact the storage system 20 through the network 6. Legal information sent to and from storage system 20 may be encrypted to enhance security.

The storage system 20 includes a storage server 22 and a database 24. The database 24 may be part of storage server 22 or a separate physical device accessible by storage server 22. The storage server 22 may be implemented using commercially available servers executing a computer program to implement the processes described herein. The storage server 22 acts as a database server to store and retrieve legal information in database 24. The storage server 22 also acts as a network server to interact with legal enterprise 10 and remote systems 30. A firewall (not shown) may be included to prevent unauthorized access to storage system 20. As legal information is generated by legal enterprise 10, it is uploaded to storage system 20 over network 6.

The system of FIG. 1 also includes remote systems 30. The remote system 30 may be used to submit legal information to storage system 20 or view legal information from storage system 20. For example, an attorney handling a client matter can upload legal information from remote system 30. Alternatively, a client may view legal information at storage system 20 from remote system 30. Different levels of access to storage system 20 are controlled through user identifications and passwords as described in further detail herein. The remote system 30 may be implemented using a general-purpose computer executing a computer program for carrying out the processes described herein. In a preferred embodiment, the remote system 30 executes a user interface application (e.g., web browser) to access storage system 20 over network 6.

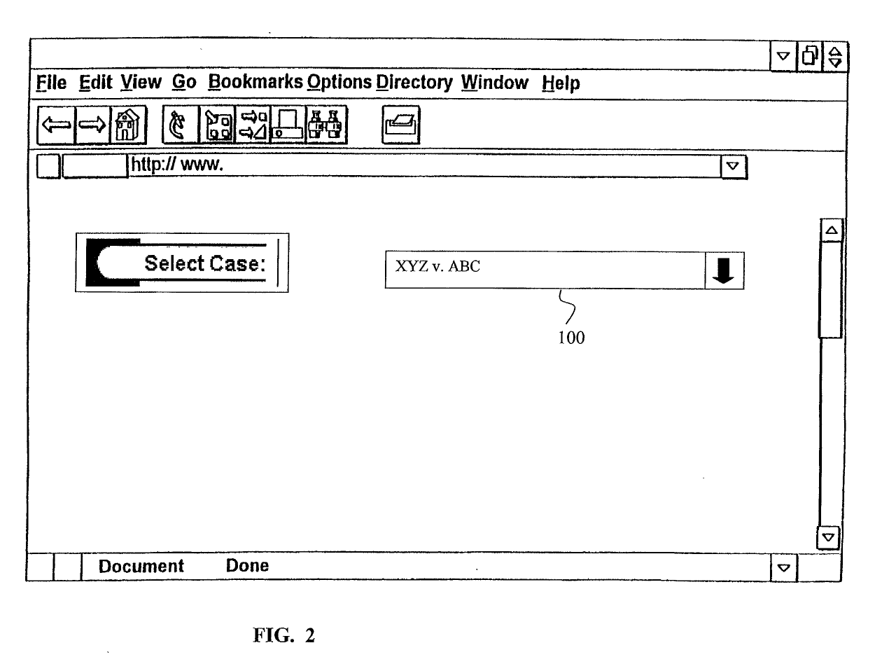

Operation of the system will now be described with reference to FIGS. 2-5. When a user contacts the storage system 20, the user is prompted for a user identification and password. Through user identification and password, the storage system 20 controls the level of interaction with legal information stored in database 24. Designated personnel of legal enterprise 10 have the discretion to set levels of access for all users, or subgroups of users. Contributors of legal information (e.g., personnel such as attorneys or paralegals of the legal enterprise 10) may submit or edit legal information as well as view existing legal information. Clients may view legal information, but generally cannot contribute or edit legal information. A user is identified as a contributor or a client through the user identification and password. In addition, access to legal information is limited on a matter-by-matter basis. A client can only view legal information for matters involving that client. Similarly, personnel with the legal enterprise may be limited to accessing legal information on only those matters that the personnel is involved with. Of course, certain members of the legal enterprise may have access to all stored legal information. Storage system 20 enforces the limits on access by requiring users to submit user identifications and passwords.

Once a user has logged in, the user is prompted to select a matter (e.g., a case in litigation, a business negotiation) for which the user wants to view or edit related legal information. FIG. 2 depicts an exemplary matter selection user interface. The matter depicted in FIG. 2 is a litigation, but the invention is not limited to providing access to information related to litigation matters. Legal information related to any legal matter such as a business negotiation or a complex transaction may be accessed through the system of FIG. 1.

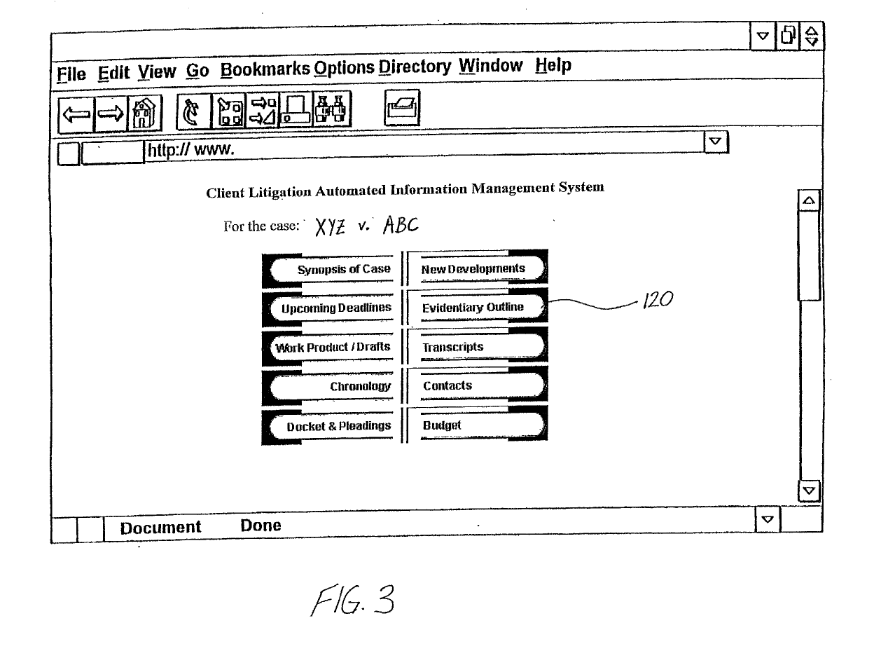

The matter selection user interface is provided by the storage server 22 to either the legal enterprise system 12 or remote system 30. In a preferred embodiment, the interface is written in HTML and the receiving system executes a web browser to generate the user interface. A list of accessible matters, determined base on user identification and password, is presented in a drop down menu 100. Once the user selects a matter from drop down menu 100, the user is presented with a main user interface such as that shown in FIG. 3. As described above, in a preferred embodiment the main user interface is an HTML document provided by storage server 22 to legal enterprise system 12 and/or remote system 30. The main user interface includes a number of icons that link the user to different types of legal information. Once such icon is the evidentiary outline icon 120.

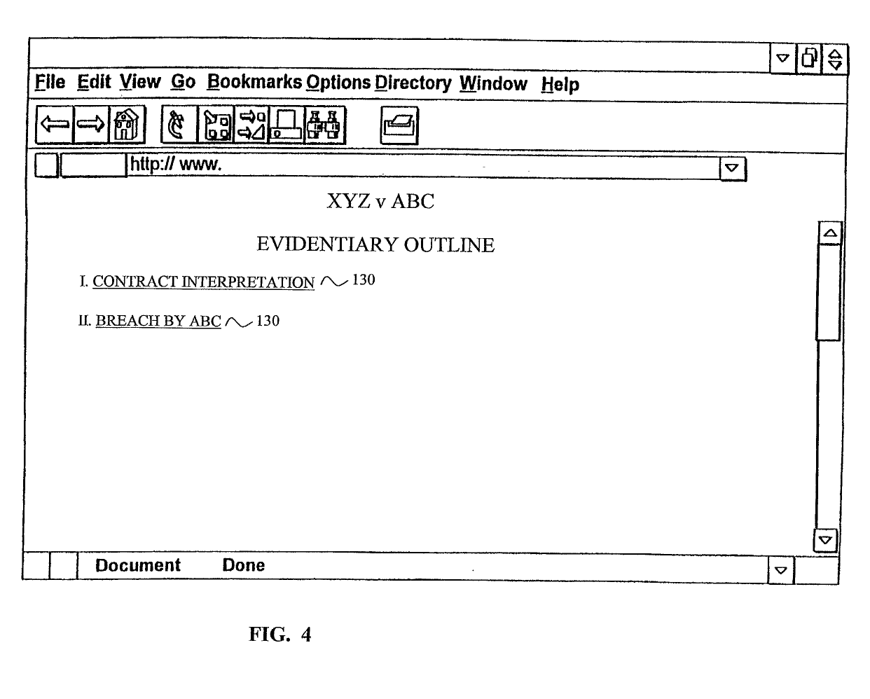

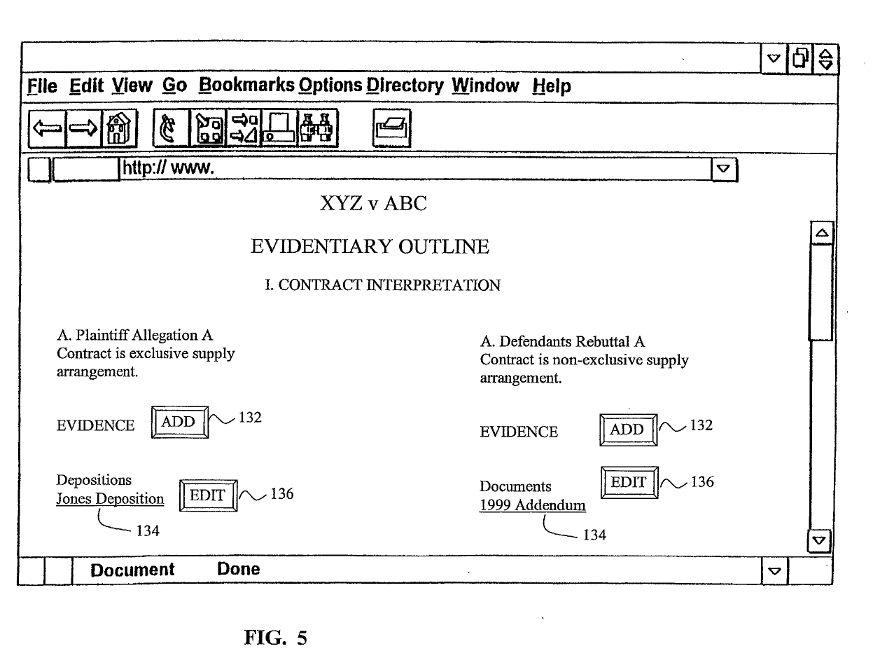

Selecting the evidentiary outline icon 120 directs the user to an evidentiary outline main page as shown in FIG. 4. As shown in FIG. 4, the evidentiary outline includes links 130 to navigate through the evidentiary outline. The evidentiary outline and associated links are stored in database 24. In a preferred embodiment, the user interfaces are written in HTML and links 130 are hyperlinks that direct the user's web browser (in legal enterprise system 12 or remote system 30) to additional content. Selecting any link 130 directs the user to a portion of an evidentiary outline such as that shown in FIG. 5. If the user has access as a contributor, the user can enter additional outline topics and subtopics through add icon 132. A user lacking authority to edit the outline topics will not be provided with the add icon 132. The add icon 132 opens the evidentiary outline file stored on database 24 and allows the user to enter additional topics and subtopics. The edited evidentiary outline file is then saved in database 24.

FIG. 5 depicts a portion of an evidentiary outline in an exemplary embodiment of the invention. As shown in FIG. 5, the evidentiary outline includes a column presenting one party's allegations and another column containing the opposing party's rebuttals. It is understood that the outline may be arranged in multiple formats and is not limited to that shown in FIG. 5. For each topic in the outline (e.g., Contract Interpretation) the evidentiary outline includes evidence supporting each party's position. For each party, there appears a listing of evidence supporting each party's position. A link 134 is provided to each item of evidence supporting the party's position. The link 134 directs the user to relevant evidence. The evidence may be in the form of documents (e.g., produced pursuant to discovery and placed in electronic form), responses to interrogatories, deposition transcripts, audio files (e.g., wav file), video (e.g., mpeg file), etc. stored in database 24. Other forms of evidence may be utilized depending on the type of legal matter as described herein. Typically, personnel of the legal enterprise create and maintain the evidentiary outline by drafting text of the outline and inserting links 134 to appropriate evidence stored in database 24.

If the user is authorized to edit the evidentiary outline, an add icon 132 and edit icon 136 will appear in the evidentiary outline user interface as shown in FIG. 5. The add icon 132 allows the user to add additional evidence that supports the party's position. Upon selecting the add icon 132, the user is prompted to designate a file or files on database 24 and assign a name for a link to that file. For example, the user can add a link to a specific portion of a deposition transcript that supports a party's position. The user, if authorized, can also edit already existing links 134 through edit icon 136. This allows the user to alter the information associated with a link 134.

Remote system 30 may also access storage system 20 over network 6. If the user at remote system has authority to create and edit legal information, then the evidentiary outline provided to remote system 30 would appear similar to that in FIG. 5. If, however, the user at remote system 30 lacks such authority (e.g., a client) then the evidentiary outline of FIG. 5 will lack the add icon 132 and edit icon 136. The user may still select links 134 to view evidence supporting the party's positions.

The evidentiary outline in FIGS. 4 and 5 is an exemplary outline related to a litigation matter. It is understood that the evidentiary outline is not limited to litigation matters, but may apply to any legal matter such as a business negotiation, complex transaction, etc. A party's position is not limited to litigation issues and may be generally referred to as a party's strategic goal in the legal matter. For example, in a business lease negotiation, a party's position may be the need for the right to sub-lease the property. The evidence supporting this position may be provided in a variety of forms, such as an insurance policy protecting the lessor from damages due to the sub-lease. Thus, the invention is not limited to providing an evidentiary outline for litigation matters.

The evidentiary outline of the present invention allows access to legal information by clients and facilitates communication between clients and counsel. Clients can access the evidentiary outline and review issues in a legal matter. Such access greatly facilitates communication between the client and counsel.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims.

What is claimed is:

1. A method for managing legal information related to at least one legal matter in a system including a legal enterprise and a storage system coupled via a network, the method comprising:
storing legal information in a database associated with the storage system, said legal information including an evidentiary outline corresponding to said legal matter, the evidentiary outline including a party's position and a link to evidence stored in the database supporting the party's position; and,
providing the legal information to a client via the network.

2. The method of claim 1 further comprising determining if the user is a client or a contributor.

3. The method of claim 2 wherein said determining is based on a user identification and password.

4. The method of claim 2 further comprising enabling the contributor to add a further link to further evidence in the database.

5. The method of claim 2 further comprising enabling the contributor to edit the link to the evidence in the database.

6. The method of claim 2 wherein if the user is determined to be a client, said providing legal information is restricted to legal information associated with that client.

7. The method of claim 2 wherein the contributor has access to legal information related to all said plurality of legal matters.

8. The method of claim 2 wherein the contributor has access to legal information related to a subset of all said plurality of legal matters.

9. The method of claim 1 wherein the legal information is encrypted prior to transmission to the storage system.

10. The method of claim 1 wherein said evidence includes documents produced through discovery.

11. The method of claim 1 wherein said evidence includes responses to interrogatories.

12. The method of claim 1 wherein said evidence includes deposition transcripts.

13. The method of claim 1 wherein said evidence includes an audio file.

14. The method of claim 1 wherein said evidence includes a video file.

15. The method of claim 1 wherein said evidentiary outline includes multiple parties' positions.

16. A system for managing legal information related to at least one legal matter, the system comprising:
a storage system for receiving legal information from a contributor at the storage system via a network;
a database associated with the storage system for storing the legal information;
said storage system receiving a request to access legal information from a user via the network;
said storage system providing the legal information to the user via the network;
said legal information including an evidentiary outline corresponding to one of said legal matters, the evidentiary outline including a party's position and a link to evidence stored in the database supporting the party's position.

17. The system of claim 16 wherein the storage system determines if the user is a client or a contributor.

18. The system of claim 17 wherein said determining is based on a user identification and password.

19. The system of claim 18 further comprising enabling the contributor to add a further link to further evidence in the database.

20. The system of claim 17 further comprising enabling the contributor to edit the link to the evidence in the database.

21. The system of claim 17 wherein if the user is determined to be a client, said providing legal information is restricted to legal information associated with that client.

22. The system of claim 17 wherein the contributor has access to legal information related to all said plurality of legal matters.

23. The system of claim 17 wherein the contributor has access to legal information related to a subset of all said plurality of legal matters.

24. The system of claim 16 wherein the legal information is encrypted prior to transmission to the storage system.

25. The system of claim 16 wherein said evidence includes documents produced through discovery.

26. The system of claim 16 wherein said evidence includes responses to interrogatories.

27. The system of claim 16 wherein said evidence includes deposition transcripts.

28. The system of claim 17 wherein said evidence includes an audio file.

29. The system of claim 16 wherein said evidence includes a video file.

30. The system of claim 16 further comprising a legal enterprise system coupled to the network, said legal enterprise system producing said legal information.

31. The system of claim 30 further comprising a remote system coupled to the network, the remote system producing the request to access legal information and receiving the legal information via the network.

32. The system of claim 31 wherein the remote system corresponds to a client.

33. A storage medium encoded with machine-readable computer program code for managing legal information related to a plurality of legal matters in a system including a legal enterprise and a storage system coupled via a network, the storage medium including instructions for causing the storage system to implement a method comprising:
receiving legal information from a contributor at the storage system via the network;
storing the legal information in a database associated with the storage system;
receiving a request to access legal information from a user via the network; and,
providing the legal information to the user via the network;
said legal information including an evidentiary outline corresponding to one of said legal matters, the evidentiary outline including a party's position and a link to evidence stored in the database supporting the party's position.

34. The storage medium of claim 33 further comprising instructions for causing the storage system to determine if the user is a client or a contributor.

35. The storage medium of claim 34 wherein said determining is based on a user identification and password.

36. The storage medium of claim 34 further comprising instructions for causing the storage system to enable the contributor to add a further link to further evidence in the database.

37. The storage medium of claim 34 further comprising instructions for causing the storage system to enable the contributor to edit the link to the evidence in the database.

38. The storage medium of claim 34 wherein if the user is determined to be a client, said providing legal information is restricted to legal information associated with that client.

39. The storage medium of claim 34 wherein the contributor has access to legal information related to all said plurality of legal matters.

40. The storage medium of claim 34 wherein the contributor has access to legal information related to a subset of all said plurality of legal matters.

41. The storage medium of claim 33 wherein the legal information is encrypted prior to transmission to the storage system.

42. The storage medium of claim 33 wherein said evidence includes documents produced through discovery.

43. The storage medium of claim 33 wherein said evidence includes responses to interrogatories.

44. The storage medium of claim 33 wherein said evidence includes deposition transcripts.

45. The storage medium of claim 33 wherein said evidence includes an audio file.

46. The storage medium of claim 33 wherein said evidence includes a video file.
